(19) United States
(12) Patent Application Publication
(10) Pub. No.: US 2005/0127311 A1
(43) Pub. Date: Jun. 16, 2005

(54) Fluid release system

(76) Inventors: Christopher Wilfred Shorey, New South Wales (AU); Patrick Alexander Heller, New South Wales (AU)

Correspondence Address: C James Bushman;Browning Bushman, 5718 Westheimer, Suite 1800, Houston, TX, 77057-5771, US

(21) Appl. No.: 10/499,492

(22) PCT Filed: Dec. 18, 2002
(86) PCT No.: PCT/AU02/01715

(30) Foreign Application Priority Data
Dec. 19, 2001 (AU) PR9642

(51) Int. Cl. F16K 31/126

(52) U.S. Cl. 251/61.1

(57) ABSTRACT

A fluid release system is disclosed comprising an apparatus that utilises fluid under pressure in operation. The system also includes a control means adapted to control the supply of fluid under pressure to the apparatus and a fluid containment reservoir adapted to contain fluid utilised by the apparatus in operation. A fluid release outlet is provided in the fluid containment reservoir, the fluid release outlet being adapted to allow fluid to be released from the fluid containment reservoir. A valve operatively associated with the fluid release outlet, is provided which is adapted to be opened to allow flow of the fluid from the fluid containment reservoir to the fluid release outlet. A pressure operated valve closure means to close the valve in use is also provided. In use, the pressure operated valve closure means is adapted to be connected to a source of the fluid under pressure in operation of the apparatus to thereby close the valve. A valve for use in the fluid release system is also disclosed.

### FIELD OF THE INVENTION

The invention relates to a fluid release system and to a valve that can be used in a fluid release system. More particularly, the present invention relates to a fluid release system such as a drainage system for a vessel containing fluids under pressure such as in an evaporative air conditioner.

### BACKGROUND OF THE INVENTION

In particular applications, it is desirable for vessels in one operating state to contain fluids and in another operating state for the fluids to be removed or released from the vessel. One known solution to remove fluids in liquid form from vessels is to allow the vessels to be drained of the liquids contained within the vessel by an operator having to manually actuate a drainage valve.

An example of a vessel which contains/utilises liquids in one operating state while requiring that they be removed in another operating state is an evaporative air conditioner. Evaporative air conditioners, which are also known in the art as ‘water cooled air conditioners’, are predominantly used in climates where relatively dry conditions are experienced. They usually comprise a frame structure defining a chamber that is surrounded by absorbent walls. In use, a water distribution system at mains pressure introduces water over the water absorbent walls and a fan assembly introduces air into the cavity so that dry air passes through the water absorbent walls and humidifies (and thereby cools) the air. The cooled humidified air is blown from an air outlet through to a dwelling in operation.

Legionnaires' disease (Legionellosis) is a serious and sometimes fatal form of pneumonia. Legionnaires' disease is caused by infection with Legionella bacteria. Although not all cases of Legionnaires' disease are severe, it can be fatal. People usually get Legionnaires' disease by breathing in Legionella bacteria in very fine droplets of water called aerosols.

Legionella bacteria thrive in warm water and warm damp places such as within evaporative air conditioning units, which can provide environments that let Legionella bacteria increase to large numbers. Legionella can be spread in the humidified air during operation of the evaporative air conditioner. It is therefore highly desirably to ensure that all water is drained from evaporative air conditioner reservoirs when the evaporative air conditioners are switched off.

The valves should be properly operated to ensure that the water in the evaporative air conditioner drains properly and secondly, the valve must be able to close properly in relatively harsh environments.

One known drain valve used in evaporative air conditioners requires manual actuation of the drain valve to ensure drainage of all liquids from the air conditioner chamber in use.

### SUMMARY OF THE INVENTION

According to a broad aspect of the invention, there is provided a fluid release system comprising:
an apparatus that utilises fluid under pressure in operation;
a control means adapted to control the supply of fluid under pressure to said apparatus;
a fluid containment reservoir adapted to contain fluid utilised by said apparatus in operation;
a fluid release outlet provided in said fluid containment reservoir, said fluid release outlet being adapted to allow fluid to be released from said fluid containment reservoir;
a valve operatively associated with said fluid release outlet, said valve being adapted to be opened to allow flow of said fluid from said fluid containment reservoir to said fluid release outlet,
a pressure operated valve closure means to close said valve in use;
wherein in use, said pressure operated valve closure means is connected to a source of said fluid under pressure in operation of said apparatus to thereby close said valve.

Preferably, operation of the control means to supply fluid to said fluid containment reservoir causes fluid under pressure to close said pressure operated valve closure means.

In one embodiment, the fluid release system further comprises:
a fluid inlet conduit adapted to supply fluid under pressure to said fluid containment reservoir; and
a bleed conduit extends from said fluid inlet conduit to said valve closure means such that in operation of the control means to supply fluid under pressure through the fluid inlet conduit to the fluid containment reservoir causes the fluid under pressure to flow through the bleed conduit to the valve closure means to thereby close the valve. Advantageously, the valve comprises a valve body having a base portion and a cap portion. The pressure operated valve closure means optionally includes:
a flexible diaphragm separating said base portion from said cap portion; and
a pressure chamber defined between said diaphragm and said cap portion,
wherein said pressure chamber is adapted to be connected to said source of said fluid under pressure to thereby cause said diaphragm to flex in the direction of the base portion.

The valve may comprise:
a fluid chamber defined between said diaphragm and said base portion;
a valve inlet extending through said base portion into said fluid chamber;
a valve outlet extending through said base portion into said fluid chamber; and
a valve seat provided in said fluid chamber, said valve seat having a valve conduit extending therein for passage of fluid from said fluid chamber to said valve outlet in use.

The valve seat may have a contoured surface substantially opposite to said diaphragm, and
wherein in use said source of said fluid under pressure flexes said diaphragm causing it to align with said contoured surface and thereby prevent flow of fluid through said valve conduit.

A cap conduit may be provided in said cap portion to allow said fluid under pressure to enter said pressure chamber in use.

The source of fluid under pressure may be provided to said cap conduit by said control means.

Optionally, said control means comprises:
a fluid inlet valve provided in said fluid inlet conduit connected to said apparatus, wherein said fluid inlet valve is adapted to be opened to allow fluid to flow in said fluid inlet conduit.

A bleed conduit may connect said fluid inlet conduit and said cap conduit.

The apparatus is in one embodiment of the invention, an evaporative cooler and said fluid is water.

According to another broad aspect of the invention, there is provided a valve comprising:
a valve body having a base portion and a cap portion;
a flexible diaphragm separating the base portion from the cap portion;
a pressure chamber defined between said diaphragm and said cap portion, said pressure chamber being adapted in use to be connected to a source of fluid under pressure adapted to cause said diaphragm to flex in the direction of the base portion;
a fluid chamber defined between said diaphragm and said base portion;
a valve inlet extending through said base portion into said fluid chamber;
said base portion having a generally concave inner surface;
a valve outlet extending through said concave inner surface of said base portion;
wherein said generally concave inner surface is shaped such that upon flexure of said diaphragm under the influence of fluid under pressure, said flexed diaphragm will make contact with and seal against said concave inner surface to thereby prevent flow of fluid through either said valve inlet or said valve outlet, or both.

A cap conduit may be provided in said cap portion to allow said fluid under pressure to enter said pressure chamber in use.

The flexible diaphragm may be layered between said cap portion and said base portion.

### BRIEF DESCRIPTION OF THE DRAWINGS

An embodiment of the present invention will now be described by way of example only, with reference to the accompanying drawings in which:

FIG. 1 illustrates a cross-sectional view of a drain valve used in the drainage system of an evaporative cooler in an open position;

FIG. 2 illustrates cross-sectional view of the drain valve of FIG. 1 in a closed position;

FIG. 3 is a schematic diagram of a drainage system for an evaporative cooler using the drain valves shown in FIG. 1 and FIG. 2 according to an embodiment of the invention;

FIG. 4a shows a cross sectional view through a base portion of a valve according to another preferred embodiment;

FIG. 4b shows a side view exploded view of a cap and diaphragm that are attached to the base of FIG. 4a when assembled;

FIG. 5 shows a top view of the cap of FIG. 4b;

FIG. 6 shows a cross-sectional view of the cap 52 through line A-A of FIG. 5;

FIG. 7 shows a bottom view of the cap of FIG. 5; and

FIG. 8 shows a top view of the base of FIG. 4a.

### DETAILED DESCRIPTION OF THE EMBODIMENTS

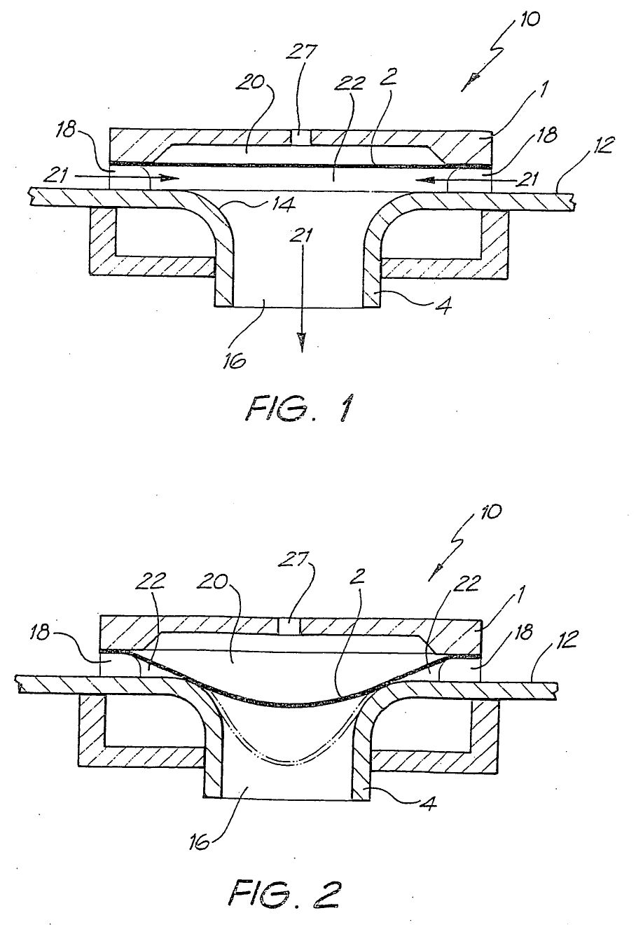

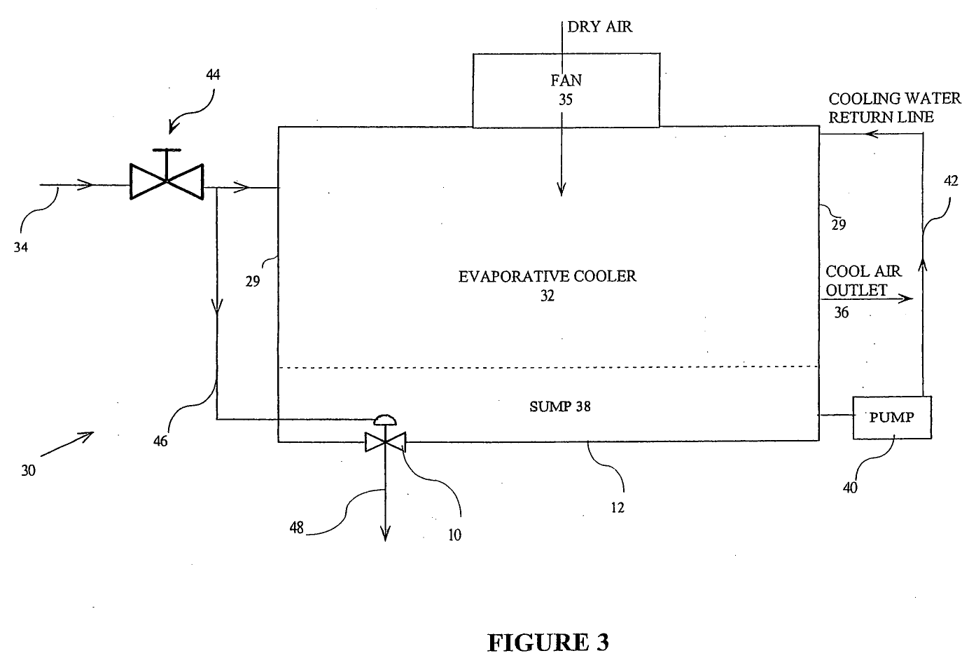

Illustrated in FIGS. 1 and 2 there is shown a cross-section view of an evaporative air conditioner drain valve 10 which is constructed so as to be inserted into a floor 12 of a fluid containment reservoir of water in the form of a sump 38 (FIG. 3) which is used in the evaporative air conditioning process as will be described further below with reference to schematic FIG. 3.

FIG. 1 shows the valve 10 in an open position while FIG. 2 shows the valve 10 in a closed position.

The valve 10 has a generally circular valve body when viewed from a top view. The valve 10 includes a base portion in the form of base 4 and a cap portion in the form of cap 1. When viewed in top view, the base 4 has a generally concave surface in the form of annular seat 14. The valve 10 also has a valve outlet in the form of discharge outlet 16 to which a fluid release outlet such as dump pipe 48 (FIG. 3) can be connected for conducting water away from the sump 38 to a storm water drain or other disposal system.

The base 4 includes valve inlets in the form of four inlet ports 18 which are equi-spaced around the perimeter of the base 4 above the annular seat, however only two are visible in cross section in FIG. 1 and FIG. 2.

Between the base 4 and cap 1 is a flexible diaphragm in the form of diaphragm 2. A pressure chamber 20 is defined between the diaphragm 2 and the cap 1. Extending through the cap 1 to the pressure chamber is a cap conduit in the form of conduit 27 which is connectable to a source of water suppled to the evaporative cooler that is under pressure as will be explained below.

A fluid chamber in the form of chamber 22 is located between the base 4 and the diaphragm 2. The flow of water through the valve 10 is shown by arrows 21.

In use as will be explained further below with reference to FIG. 3, water under pressure causes the diaphragm 2 to flex in the direction of the base 4 as shown in FIG. 2. The generally concave inner surface of the annular seat 14 is shaped such that upon flexure of the diaphragm 2 under the influence of water under pressure in the pressure chamber 20, the flexed diaphragm 2 makes contact with and seals against the concave inner surface of the annular seat 14 to thereby prevent flow of water through the inlet port 18 and the discharge outlet 16.

A fluid release system in the form of a drainage systems 30 for an evaporative cooler 32 using the valve 10 described above will now be described with reference to FIG. 3. It will be appreciated that FIG. 3 is a schematic diagram of the drainage system for the evaporative air cooler and therefore the diagram does not represent the actual dimensions of the evaporative air cooler or the construction of the valve 10. The evaporative cooler 32 is a conventional evaporative cooler having an internal chamber which is covered by absorbent side walls 29.

A gate valve 44 is also provided in the water inlet pipe 34 to supply mains pressure water to the evaporative cooler during cooling operation of the evaporative cooler 32 so that in use the absorbent walls 29 absorb water from the inlet pipe 34.

The evaporative cooler 32 is also provided with a fan 35 located on the top of the evaporative cooler 32. The evaporative cooler 32 sucks in dry air from the atmosphere and passes that dry air over the water saturated absorbent walls 29. As is known in the art, the passage of dry air over the absorbent walls 29 that are saturated with liquid water causes the dry air to humidify and thereby cool. The evaporative cooler 32 is provided with a cool air outlet 36 to pass the cool air to a cool air distribution system (not shown) which distributes the cool air within the interior of a building.

The evaporative cooler 32 also includes a fluid containment reservoir in the form of sump 38 in which water, having passed over the absorbent walls 29, collects in the bottom of the evaporative cooler 32. A pump 40 is provided to circulate water located in sump 38 and return it via cooling water return line 42 to the top of the evaporative cooler 32 and redistribute the water over the absorbent walls 29.

It is known in the art that control systems are provided to operate the evaporative cooler and hence, the control system to operate the evaporative cooler 32 is not described in detail here.

A bleed line 46 is connected to the water inlet conduit 34 downstream of the gate valve 44 and is connected to conduit 27 of the valve 10. The bleed line 46 provides water under pressure from the mains water supply to the pressure chamber 20 of the valve 10.

A dump pipe 48 is connected to the outlet 16 of the valve 10 and is used to drain water that has collected in the sump 38 during operation. The valve 10 is located in this embodiment, at the base of the sump 38 and at the opening of the dump pipe 48. As will be described further below, the valve 10 closes when the evaporative cooler 32 is in operation to allow water to collect in the sump 38 and opens when the evaporative cooler 32 is not in operation to allow water to drain from the sump 38 via dump pipe 48.

In operation, the gate valve 44 is turned on and a water supply is provided by the water inlet pipe 34. Water is absorbed by the absorbent walls and excess water collects in the sump 38. Water under pressure also passes into bleed line 48 which increases the pressure within the pressure chamber 20 and causes the diaphragm 2 to flex toward the concave shaped annular seat 14 of the valve 10 as shown in the closed position of FIG. 2. The flexure of the diaphragm 2 causes the inlet ports 18 and the outlet 16 in the valve 10 to be sealed and prevents drainage of water from sump 38.

The dashed lines in FIG. 2 show the diaphragm 2 over-flexing when a higher water pressure is applied in the chamber 20. The dashed lines of the diaphragm over-flexure are shown to illustrate that precise control of water pressure supplied to the chamber 20 is advantageously not required because mains water pressure is sufficient to flex diaphragm 2 and close the valve 10, which saves on the costs of installing and operating the drainage system 30.

The gate valve 44 is turned off by the control system of the evaporative cooler 32 when the evaporative cooler 32 is shut down. The pressure in the bleed line 46 reduces which reduces the pressure within pressure chamber 20, thereby causing the flexible diaphragm to flex back toward its open position as shown in FIG. 1. This allows the water within the sump 38 to be drained via dump pipe 48.

It will be appreciated that the valve 10 advantageously allows water within sump 38 to be drained from the evaporative cooler 32 when the evaporative cooler 32 is no longer in operation. Advantageously, it is not necessary for the drainage valve 10 in the sump 38 of the evaporative cooler 32 to be manually opened to allow water in sump 38 to be released through dump pipe 48. Furthermore, because the valve 10 is actuated by the mains water supply supplied to the evaporative cooler 32, it is not necessary to provide a separately actuated valve in the dump pipe 48. This is important, because it reduces the cost of providing a drainage system to the evaporative cooler.

Another advantage of the valve 10 is the combination of the diaphragm 2 and the concave shaped annular seat 14, as the annular seat 14 is shaped so that it fits the natural flexure of the diaphragm 2 when the water under pressure is supplied to the pressure chamber 20. This prevents the diaphragm 2 from over-stretching which increases the life of the diaphragm 2 in use. Furthermore, it will be appreciated that the only moving part in valve 10 is the diaphragm 2, which advantageously reduces the cost of operation, manufacture and maintenance.

Furthermore, when the valve 10 is used in the evaporative air cooler 32 to drain water from the sump 38 after use, the operation of the valve 10 as described above ensures that there is an automatic discharge mechanism for discharging water from the sump 38. The automatic discharge of water from the sump 38 when the evaporative air cooler is not in use ensures that Legionella bacteria does not thrive in water left in the sump 38 after use of the evaporative air cooler 32.

The valve 10 ensures that all water is drained from the sump 10 when the evaporative air cooler 32 is switched off and the valve 10 is able to close properly in relatively harsh environments due to the resilience of the diaphragm 2.

It will be appreciated that in other embodiments the sump 38 may not be located within the chamber of the evaporative cooler 32 but could be separate from the chamber of the evaporative cooler 32.

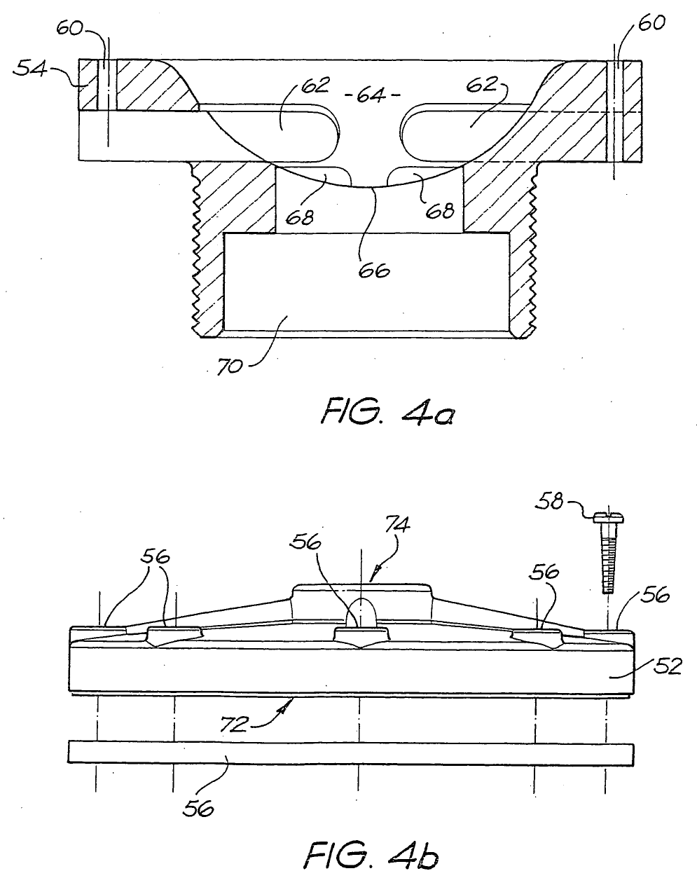

Another preferred embodiment of a valve that can be used in a fluid release system will now be described with reference to FIGS. 4 to 8. Referring to FIG. 4a there is shown a cross sectional view through a base portion in the form of base 54 of valve 50 according to another preferred embodiment of the invention. FIG. 4b shows a side view exploded view of a cap portion in the form of cap 52 and a flexible diaphragm 56 for valve 50.

In assembly, the flexible diaphragm 56 is sandwiched between the base 54 and the cap 52. The cap 52 is coupled to the base 54 by eight screws which are driven into screw holes 56 provided in the cap 52 and respectively into corresponding base screw holes 60. One of the screws is shown in FIG. 4 in the form of screw 58.

In assembly, screw 58 is driven into screw hole 56 and pierces the flexible diaphragm 56 before being driven into the corresponding base screw holes 60. The even distribution of the base screw holes 60 about the perimeter of the base 54 and the screw holes 56 about the perimeter of the cap 52, ensures that the diaphragm 56 is firmly and evenly sandwiched between the, base 54 and the cap 52.

The base 54 includes four equally spaced inlets in the form of inlet ports 62 which extend into the base 54 through to a fluid chamber in the form of chamber 64 which is defined between the diaphragm 56 and the base 54. The base 54 includes a concave surface as shown by solid line 66, which forms a annular seat 66 around four valve outlets in the form of outlets 68. The outlets 68 connect to an outlet passage in the form of discharge outlet 70 as shown in FIG. 4a.

Referring now to FIG. 4b, in assembly between the diaphragm 56 and the cap 52 is defined a pressure chamber 72, as the internal surface of the cap 52 provides a chamber when connected to the diaphragm 2 and the base 54 when the diaphragm 2 is in the unflexed position.

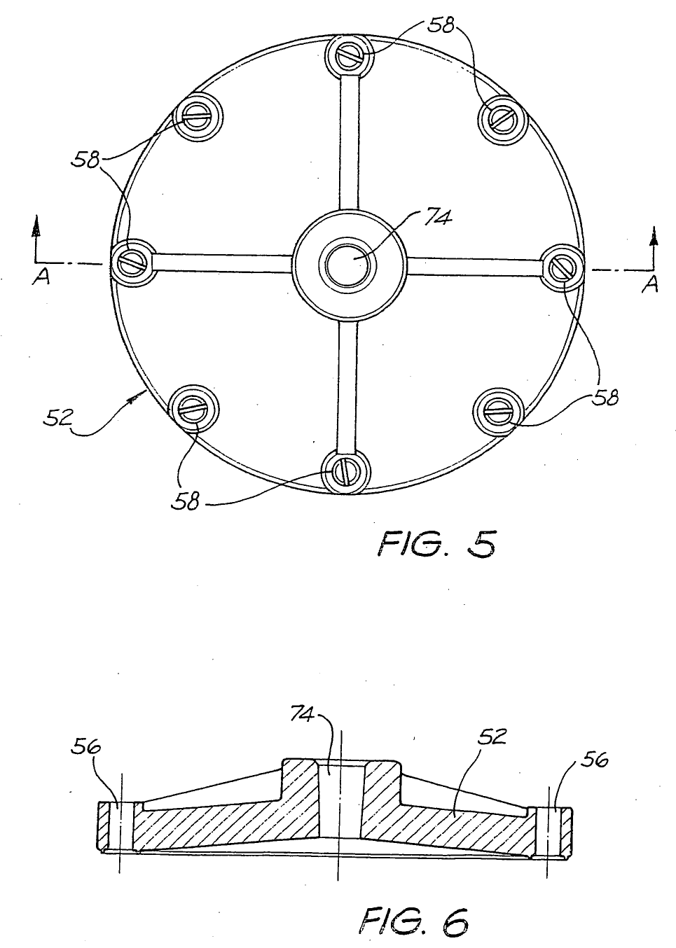

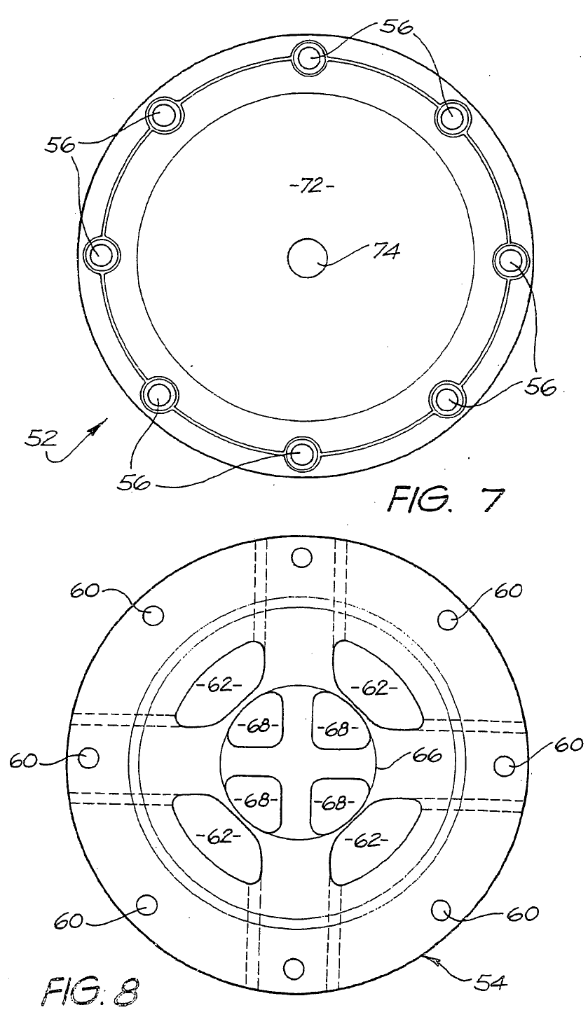

FIG. 5 which shows a top view of the cap 52 connected to the base 54 by the screws 58. FIG. 6 shows a cross-sectional view of the cap 52 through line A-A of FIG. 5, and FIG. 7 shows a bottom view of the cap 52 of FIG. 5.

The centre of the cap 52 includes the bleed conduit 74 which connects to a bleed line such as the bleed line 46 shown in FIG. 3. As shown in FIG. 6, the conduit 74 extends throughout the cap 52 towards the pressure chamber 72.

Referring now to FIG. 8, there is shown a top view of the base 54 with the screw holes 60 for receiving screws 58 in assembly. The inlet ports 62 are shown surrounding the generally concave annular seat 66 and the outlet ports 68 are shown on the concave shaped surface lying below the inlet ports 62.

The valve 50 operates in the same manner as the valve 10 described above. In this regard, a fluid under pressure is supplied to fluid conduit 74 which increases the pressure in the pressure chamber 72 thereby causing the diaphragm 56 to flex towards the concave shape surface 67 of the base 54. Flexure of the diaphragm 56 causes it to lie flush against annular seat 66, thereby sealing both the inlet 62 and the outlet 68 so that the valve 50 is in a closed position to prevent fluids flowing from the inlet ports 62 to the outlet ports 68 and then out through the discharge outlet 70.

When a fluid under a high pressure source connected to the conduit 74 is released, the fluid pressure in the chamber 72 reduces and the diaphragm 56 springs back to its unflexed state, thereby moving away from the concave annular sear 66 so that it is substantially horizontal when viewed in cross section. This allows fluid to flow from the inlet ports 62 to the outlet ports 68 and out towards discharge outlet 70.

It will be appreciated that the valve 50 could be used in the drainage system 30 for the evaporative cooler 32 or in other applications which require fluid release systems requiring a valve to be actuated by a pressure source.

The base 54 and the cap 52 are made from glass reinforced plastic manufactured in a mould according to methods known to those skilled in the art. The diaphragm 56 is made from unreinforced rubber and the screws 58 are made from stainless steel. However, in other embodiments, the valve 50 could be made from alternative materials according to the fluid release applications in which it is employed.

It will also be appreciated that the present drainage system and valve can be applied to other applications where fluids are held in an apparatus under pressure. For example, the valve could be placed in a water tank and might be actuated automatically by the water pressure within the water tank. Additionally, instead of water, the fluid may be a gas and the sump a gas vessel.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

1. A fluid release system comprising:
an apparatus that utilises fluid under pressure in operation;
a control means adapted to control the supply of fluid under pressure to said apparatus;
a fluid containment reservoir adapted to contain fluid utilised by said apparatus in operation;
a fluid release outlet provided in said fluid containment reservoir, said fluid release outlet being adapted to allow fluid to be released from said fluid containment reservoir;
a valve operatively associated with said fluid release outlet, said valve being adapted to be opened to allow flow of said fluid from said fluid containment reservoir to said fluid release outlet,
a pressure operated valve closure means to close said valve in use;
wherein in use, said pressure operated valve closure means is adapted to be connected to a source of said fluid under pressure in operation of said apparatus to thereby close said valve.

2. A fluid release system as claimed in claim 1, wherein operation of the control means to supply fluid to said fluid containment reservoir causes fluid under pressure to close said pressure operated valve closure means.

3. A fluid release system as claimed in claim 1 or claim 2, further comprising:
a fluid inlet conduit adapted to supply fluid under pressure to said fluid containment reservoir; and
a bleed conduit extends from said fluid inlet conduit to said valve closure means such that in operation of the control means to supply fluid under pressure through the fluid inlet conduit to the fluid containment reservoir causes the fluid under pressure to flow through the bleed conduit to the valve closure means to thereby close the valve.

4. A fluid release system as claimed in claims 1 or 2, wherein said valve comprises a valve body having a base portion and a cap portion;
a flexible diaphragm separating said base portion from said cap portion; and
a pressure chamber defined between said diaphragm and said cap portion,
wherein said pressure chamber is connected to said source of said fluid under pressure to thereby cause said diaphragm to flex in the direction of the base portion.

5. A fluid release system as claimed in claim 4, wherein said valve comprises:
a fluid chamber defined between said diaphragm and said base portion; and
a valve inlet extending through said base portion into said fluid chamber;
a valve outlet extending through said base portion into said fluid chamber;
a valve seat provided in said fluid chamber, said valve seat having a valve conduit extending therein for passage of fluid from said fluid chamber to said valve outlet in use.

6. A fluid release system as claimed in claim 5, wherein said valve seat has a generally concave surface substantially opposite to said diaphragm, and
wherein in use said source of said fluid under pressure flexes said diaphragm causing it to align with said generally concave surface and thereby prevent flow of fluid through said valve conduit.

7. A fluid release system as claimed in claims 4, wherein a cap conduit is provided in said cap portion to allow said fluid under pressure to enter said pressure chamber in use.

8. A fluid release system as claimed in claim 7, wherein said source of fluid under pressure is provided to said cap conduit by said control means.

9. A fluid release system as claimed in claim 3, wherein said control means comprises:
a fluid inlet valve provided in said fluid inlet conduit connected to said apparatus, wherein said fluid inlet valve is adapted to be opened to allow fluid to flow in said fluid inlet conduit.

10. A fluid release system as claimed in claim 3, wherein said bleed conduit connects said fluid inlet conduit and said cap conduit.

11. A fluid release system as claimed in any one of claims 1 or 2, wherein said apparatus is an evaporative cooler and said fluid is water.

12. A valve comprising:
a valve body having a base portion and a cap portion;
a flexible diaphragm separating the base portion from the cap portion;
a pressure chamber defined between said diaphragm and said cap portion, said pressure chamber being adapted in use to be connected to a source of fluid under pressure adapted to cause said diaphragm to flex in the direction of the base portion;
a fluid chamber defined between said diaphragm and said base portion;
a valve inlet extending through said base portion into said fluid chamber;
said base portion having a generally concave inner surface;
a valve outlet extending through said concave inner surface of said base portion;
wherein said generally concave inner surface is shaped such that upon flexure of said diaphragm under the influence of fluid under pressure, said flexed diaphragm will make contact with and seal against said concave inner surface to thereby prevent flow of fluid through either said valve inlet or said valve outlet, or both.

13. A valve as claimed in claim 12, wherein a cap conduit is provided in said cap portion to allow said fluid under pressure to enter said pressure chamber in use.

14. A valve as claimed in claim 12 or claim 13, wherein said flexible diaphragm is layered between said cap portion and said base portion.

15-16. (canceled)
